(19) United States
(12) Patent Application Publication
(10) Pub. No.: US 2006/0168244 A1
(43) Pub. Date: Jul. 27, 2006

(54) Method and apparatus for an image server

(76) Inventors: Patrik Anderson, Lund (SE); Gustav Kalvesten, Malmo (SE); Julien Masnada, Lund (SE); Kristofer Johansson, Malmo (SE); Peter Berggren, Lund (SE); Ulf Olsson, Malmo (SE)

Correspondence Address: IP CREATORS, P. O. BOX 2789, CUPERTINO, CA, 95015, US

(21) Appl. No.: 11/286,828

(22) Filed: Nov. 23, 2005

Related U.S. Application Data
(63) Continuation of application No. 09/816,620, filed on Mar. 23, 2001.
(60) Provisional application No. 60/191,872, filed on Mar. 23, 2000.

(51) Int. Cl. G06F 15/16

(52) U.S. Cl. 709/227

(57) ABSTRACT

A method and apparatus is disclosed for an image server capable of acquiring images and transmitting them across a network with header information and formatting specific to the destination selected by the user. Destinations include, other computers on the network, database servers, e-mail servers, fax servers, file servers, etc. Additionally, the image server may be set up via the network whereby logical and physical destinations, protocols for each destination, required header information for each destination, and any archival or alternate destinations may be specified. Each server may handle more than one image acquisition device. Each device may be programmed to acquire and update all or part of its configuration parameters via a configuration file/page available over the network at location(s) pointed to by the administrator during the setup phase of the device. All servers may be configured to perform in a uniform manner and to update their parameters and protocols via the configuration file/page. The server may be used across a wide range of networks including: local area networks (LANs), wide area networks (WANs), virtual private networks (VPNs) and the Internet.

### CROSS-REFERENCE TO RELATED APPLICATION

This application is a continuation of pending U.S. patent application Ser. No. 09/816,620 entitled “METHOD AND APPARATUS FOR AN IMAGE SERVER” filed on Mar. 23, 2001 which claims priority from Provisional Application Numbers: 60/191,872, entitled “META INFORMATION HANDLING FOR A NETWORK DOCUMENT” filed on Mar. 23, 2000 (Attorney Docket # AXISP006P) both of which is are incorporated herein by reference in their entirety.

### NOTICE REGARDING COPYRIGHTED MATERIAL

A portion of the disclosure of this patent document contains material which is subject to copyright protection. The copyright owner has no objection to the facsimile reproduction by any one of the patent document or the patent disclosure as it appears in the public Patent Trademark Office file or records, but otherwise reserves all copyright rights whatsoever.

### BACKGROUND OF THE INVENTION

1. Field of the Invention

The present invention relates to a system and a method for transmitting image information acquired as a image file to selected destinations on a network in formats which vary depending on the destination selected.

2. Description of the Related Art

The development of computers has resulted in a different way of handling documents and images. Today documents and images are handled both on paper and in a digital form in computers. This means that there is often a desire to transform a paper document or an image into digital form to adopt the document for computer handling. The transition from a document on paper to a digital document or an image to a digital representation of said image is performed by some kind of image acquisition. The acquired image is captured as a digital image file, which can be treated in a computer.

A digital image file holds a lot of information that is heavily resource demanding for the computer to analyse and process. Therefore a user has to add extra information to the computer about the digital image file instructing the computer how to treat the digital image file. This extra information could for example be searchable information for a database or other information about the contents of the digital image file.

Today, when extra information has to be added to a document that is to be scanned, the user has to go to a scanner and scan the document and then go to a client station and input the extra information. At the client station, where the user is able to access the scanned document, the user has to find the file in the file system before the extra information can be added. This method is inefficient for the user as it adds extra steps after the actual scanning process. It also requires access to a client station where the extra information can be added.

There is however another way of obtaining the extra information. This could be achieved by means of software interpreting the scanned document image and using different image processing and OCR (Optical Character Recognition) techniques to derive the extra information from the document itself The problem with this method is that it is very complex and resource requiring. There might even be a need of servers for the processing of the scanned document or image. The processing software also needs to know exactly how the different documents are formatted to be able to extract the extra information. Thus it is not able to adapt to new documents very easily.

In EP 0 748 107 A2 a method of scanning and adding extra information is disclosed. According to this document information regarding a document to be scanned is written or printed in a form. The form is then scanned and the extra information is extracted using an image recognition technique. The information extraction is not as complex for the scanning device as when the information is extracted from the document itself, but still an image processing is required and other problems are added. The scanning device must be able to recognise that the paper it is scanning is an information form and therefore only a restricted amount of different designs of the form could be used. If a form is changed, e.g. in a case when some other information is needed, the scanning device must be reprogrammed to be able to extract the information.

What is needed are more flexible ways of acquiring and transmitting images and information related to the images.

### SUMMARY OF THE INVENTION

A method and apparatus is disclosed for an image server capable of acquiring images and transmitting them across a network with header information and formatting specific to the destination selected by the user. Destinations include, other computers on the network, database servers, e-mail servers, fax servers, file servers, etc. Additionally, the image server may be set up via the network whereby logical and physical destinations, protocols for each destination, required header information for each destination, and any archival or alternate destinations may be specified. Each server may handle more than one image acquisition device. Each device may be programmed to acquire and update all or part of its configuration parameters via a configuration file/page available over the network at location(s) pointed to by the administrator during the setup phase of the device. All servers may be configured to perform in a uniform manner and to update their parameters and protocols via the configuration file/page. The server may be used across a wide range of networks including: local area networks (LANs), wide area networks (WANs), virtual private networks (VPNs) and the Internet.

The header transmitted with each image includes meta information which is extra information about the image, its contents or any other information related to this specific document. This meta information could be used to control how the digital image file is to be treated by another user or a device, such as a database, file server, computer etc. It is therefore suitable that the user who transmits a digital image file adds meta information to it, in order to enable the file to be treated properly later on. The meta information also simplifies the later treatment of the digital image file and enables automatic treatment without resource requirements as no new instructions for the digital image file has to be added.

This server prompts the user to input meta information that are to be connected to the digital image file at the time and place of the image acquiring operation. The required information may vary between destinations. There is no extra effort involved and the data processing is diminished. A user that wants to transmit a document to a recipient that needs instructions about how to treat the document can perform the image acquiring, transmitting and instructing in one step.

In another preferred embodiment, the system further comprises means utilising a global configuration file/page for dynamic control of the requesting of the meta information. Thus, the information requested for by the system could easily be varied in a countless number of ways to suit different image files or destination applications.

In yet another preferred embodiment, the means utilising a control file for dynamic control in response to an inputted destination for the digital image file is arranged to request meta information in accordance with requirements of said inputted destination. The request of the meta information could be controlled in such a way that if the user enters a specific destination for the digital image file, specific requests that suits the destination are made.

In yet another preferred embodiment, the system further comprises means for controlling the format of the meta information transmitted to the data network. Hereby, the files sent over the network are made compatible for the destinations and the user will not have to adapt the information format. The system could use some inputted information to determine what format the meta information should be transmitted in.

The objects of the invention is also accomplished by a method for providing image information with meta information, which image information is acquirable as a digital image file from a selected image by an image information acquiring means, comprising the steps of, in connection with an image information acquiring operation, requesting meta information regarding the selected image, inputting, in response to the request, the meta information by means of an input device, connecting said meta information regarding said selected image to the digital image file, and transmitting said meta information regarding said selected image and said image information acquired as a digital image file, to said data network.

This method enables a user to input the meta information to be connected to the digital image file at the time and place of the image acquiring operation. There is no extra effort involved and the data processing is diminished. A user that wants to transmit a document to a recipient that needs instructions about how to treat the document can perform the image acquiring, transmitting and instructing in one step. Additionally, an advantage of requesting for the meta information is that the system does not have any trouble determining what kind of information that is being inputted and that the user does not need to remember any order in which specific data has to be inputted.

The image may be acquired by any image acquisition device, including a scanner. A scenario where this could be useful is if a user scans a document at a scanning device such as a digital copier, scanner or MFP the user would be able to attach some extra information to the image, e.g. if an invoice is scanned the user could connect an invoice number and last payment date to the image. This connected meta information can then e.g. be used by different applications such as an accounting software or for storing it in a database server under a unique name.

In a preferred embodiment, the method further comprises the step of utilising a control file for dynamic control of the requesting of the meta information. This means that a control can be made so that a user inputs the meta information needed for the digital image file. Also, the requesting of information could depend on what the user inputs. For example a specific destination for the digital image file could be inputted by the user and the requests could then be made to adapt the meta information to an application at the destination.

In another preferred embodiment, the control file is editable by an administrator. This means that an administrator could control the requesting of information to e.g. suit the needs of an application or a person. This allows every administrator to adapt the requesting of information to suit the data network.

In yet another preferred embodiment, the method further comprises the step of controlling the format of the meta information transmitted to the data network. This is advantageous as the information and the digital image file thus could be adopted to suit the destination application, which could have very different needs if it is an e-mail recipient or a database.

Preferably, the method further comprises the step of validating the inputted information. Hereby, the information can be controlled to be in the right format. For example if an amount is asked for the validation should ensure that the inputted information is a number.

### BRIEF DESCRIPTION OF THE DRAWINGS

The present invention will be readily understood by the following detailed description in conjunction with the accompanying drawings, wherein like reference numerals designate like structural elements, and in which:

FIG. 1 is a schematic view of a data network with different applications including the scan server according to the invention.

FIG. 2 shows the data structures associated with the administrative setup of a scan server including mapping of logical and physical addresses and protocols specific to each destination.

FIG. 3 shows a global configuration page/file which is accessible to the various scan servers shown in FIG. 1 and the acquisition of which results in a reconfiguration of each of the scan servers without administrative involvement.

FIG. 4 is a combined hardware and software module diagram for an embodiment of the scan server.

FIG. 5A shows the data structures associated with logical-to-physical destination mapping and protocols therefore as found on the scan server after administrative setup.

FIG. 5B shows the data structures associated with configuration of user interface procedures and image and header input parameters and formats after acquisition or updating of the global configuration file by the scan server.

FIG. 6A is a process flow diagram associated with administrative setup of a scan server.

FIG. 6B is a process flow diagram associated with run-time performance of a selected scan server.

### DETAILED DESCRIPTION OF THE INVENTION

A method and apparatus is disclosed for an image server capable of acquiring images and transmitting them across a network with header information specific to the destination selected by the user. In an embodiment of the invention the header may be a simple text file containing image description parameters, e.g. meta data, entered by the user. In more complex embodiments of the invention the header information could include destination specific commands which will trigger an action on the destination device/server. Additionally include Destinations include, other computers on the network, database servers, e-mail servers, fax servers, file servers, etc. Additionally, the image server may be set up via the network whereby logical and physical destinations, protocols for each destination, required header information for each destination, and any archival or alternate destinations may be specified. Each server may handle more than one image acquisition device. Each device may be programmed to acquire and update all or part of its configuration parameters via a configuration file/page available over the network at location(s) pointed to by the administrator during the setup phase of the device. All servers may be configured to perform in a uniform manner and to update their parameters and protocols via the configuration file/page. The server may be used across a wide range of networks including: local area networks (LANs), wide area networks (WANs), virtual private networks (VPNs) and the Internet.

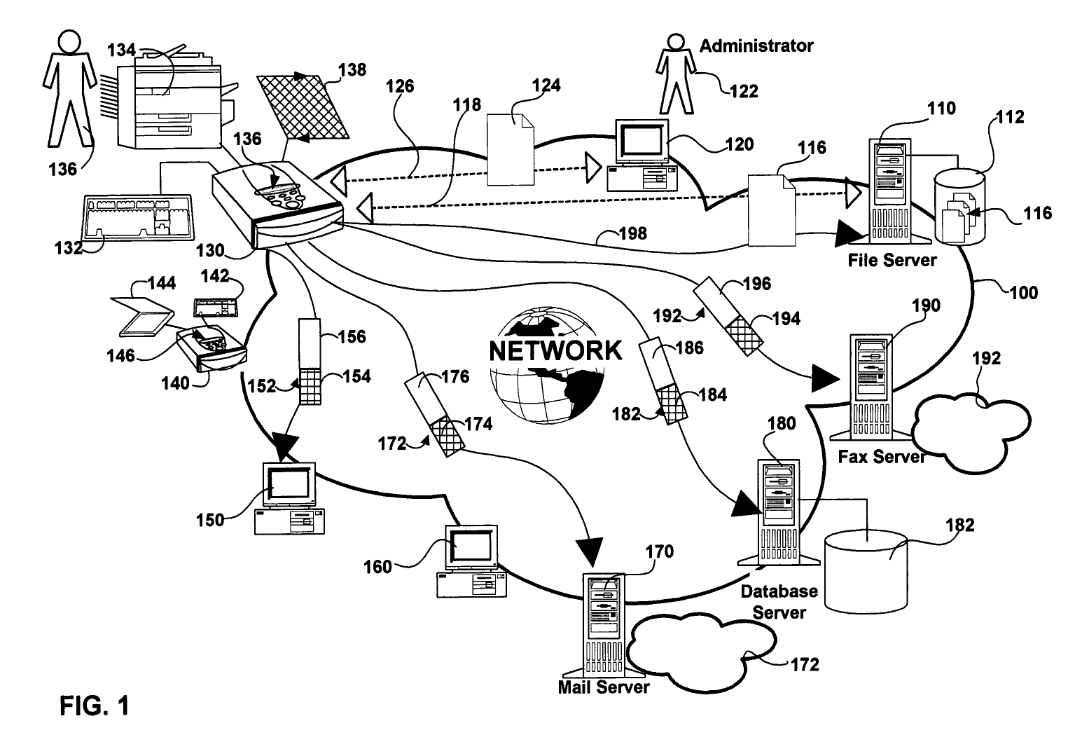

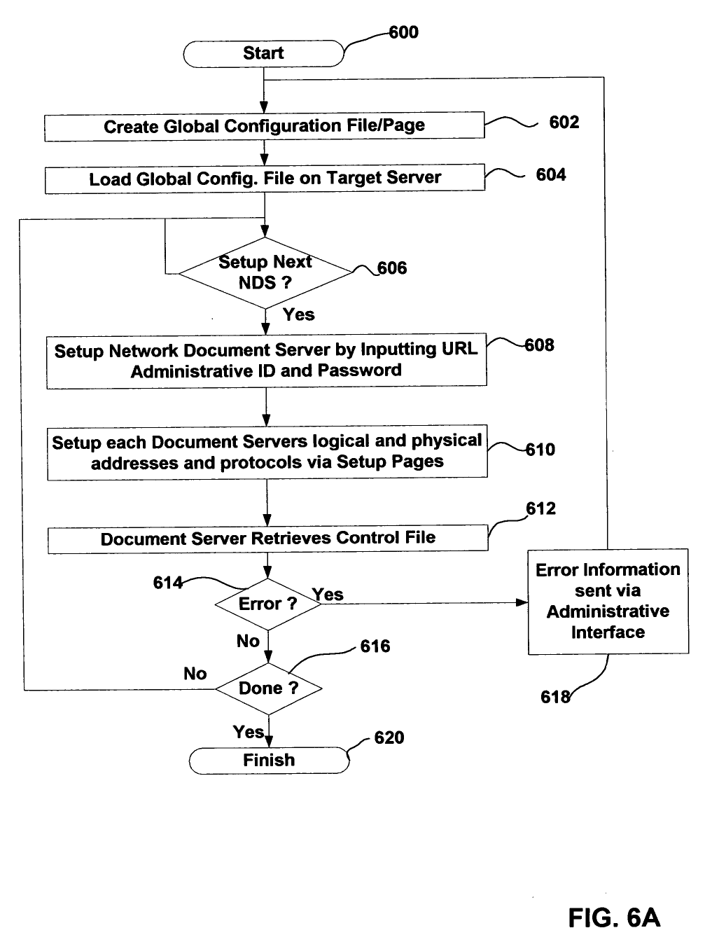

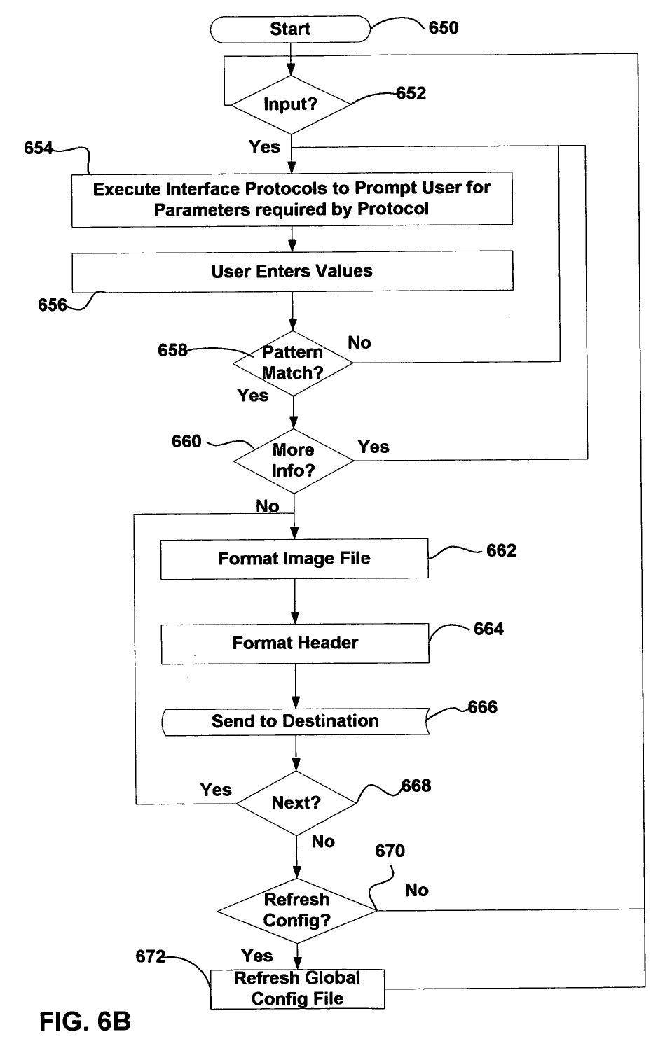

FIG. 1 is a schematic view of a data network with different applications including the scan servers according to the invention. A network 100 is shown with various image input nodes, e.g. image servers 130, 140. The image servers are coupled to one or more image input devices. Each image server implements processes for image and header acquisition and distribution in accordance with dynamically reconfigurable parameters available to the servers over the network. Processes 138 for server 130 are shown in greater detail in FIGS. 6A-B. In the embodiment of the invention shown in FIG. 1 the image input device to scan server 130 is a digital copier 134 and the image input device to scan server 140 is a scanner 144. In alternate embodiments of the invention image input may be accomplished by a fax machine, a digital camera etc. Each scan server includes input/output (I/O) devices, for the entry and viewing by a user 136 of selected destinations for the image input and such other header information as may be required as a result of the dynamically configurable setup of the scan server. Scan server 130 includes a multi line alpha numeric display 136 and a keyboard 132. Scan server 140 includes a keyboard 142 and a corresponding alpha numeric display 146.

The network includes a number of additional nodes with which the scan server can communicate. Those nodes include client computers 120, 150, 160; an FTP server 110, a fax server 190, a database server 180, and a mail server 170. The file server 110 couples with storage 112 which includes global configuration page(s)/file(s) 114. The fax server 190 couples to a public switched telephone network (PSTN) 192. The database server 180 couples to a storage medium 182 for storage of information. The mail server 170 delivers mail over network 100 or network 172.

All image acquisition servers, e.g. servers 130, 140 on the network may be remotely configured across the network. Configuration parameters include destination addresses logical-physical and/or physical for a variety of destinations. Header information to accompany the transmission of the image across the network. Alternate, or backup transmission sites for archiving of data. Protocols for data conversion or formatting specific to each destination. These parameters may be reconfigured either on a device by device basis or globally across all devices, or with a combination of the two.

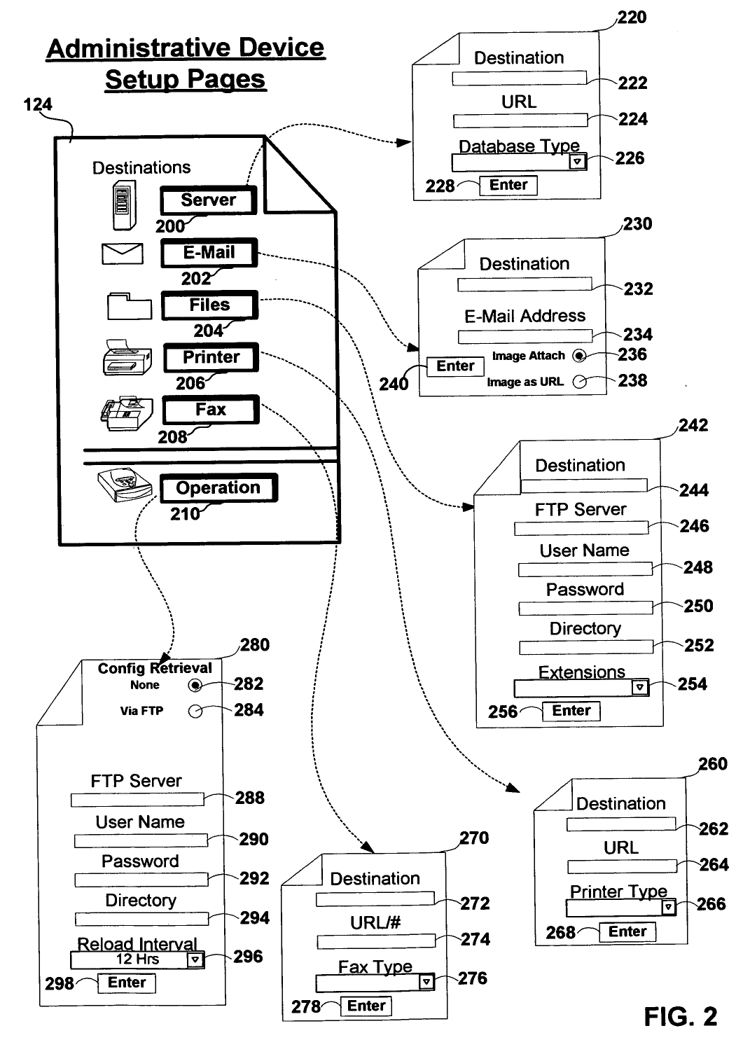

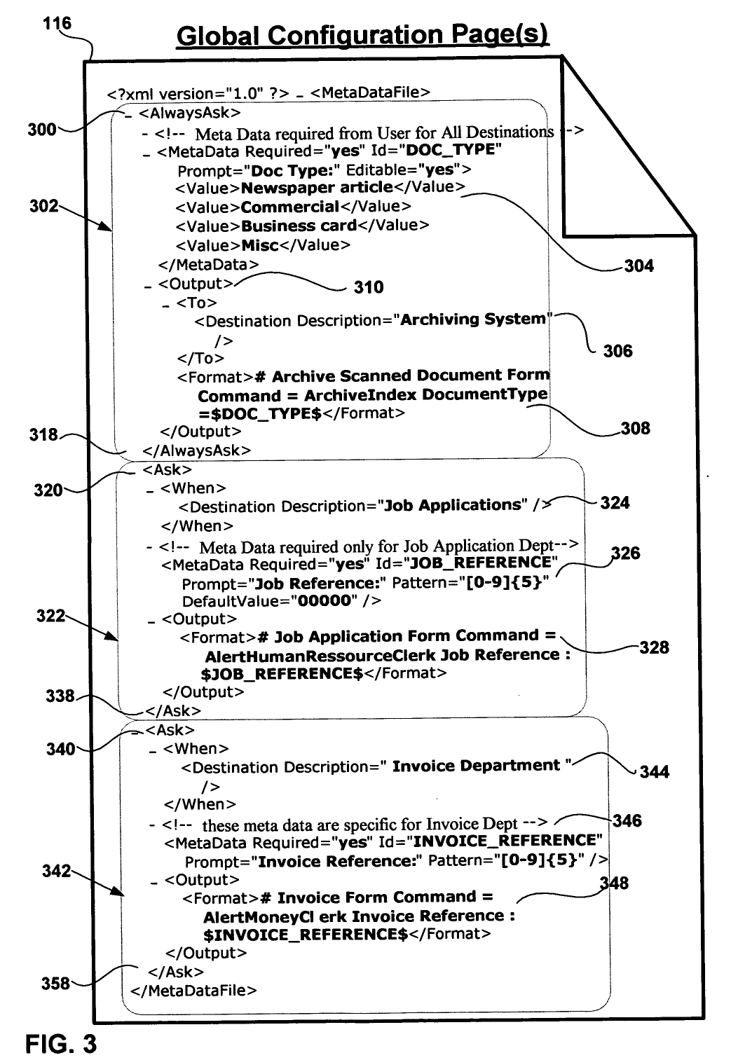

In the embodiment of the invention shown in FIG. 1 a combination of remote setup techniques both device specific and global are implemented. In this embodiment of the invention an administrator using a network address associated with the selected image server, e.g. server 130 inputs via a computer, e.g. computer 120, the appropriate address for the server, e.g. uniform resource locator (URL) and is immediately presented 126 with one or more administrative web pages 124 delivered by the server 130. The first of these pages (Not shown) is a login page requiring appropriate user name and password. After a successful login the administrator is presented with an administrative setup pages (See FIG. 2) which allow the server to be loaded with a series of physical destinations for the images and with logical names corresponding with those destinations. Possible destinations on the network 100 include all client computers and servers. In this embodiment of the invention the administrator may as discussed in the following FIG. 2 also enter information and protocols appropriate to the destination. For a file transfer server destination, the user name, password, directory, etc. would be required. For a mail server destination the manner of attachment of the image could be specified. For a database server, the database type or field mapping. In an embodiment of the invention the administrator may specify the location of a global configuration file/page, the update interval therefore, and any required username, password needed to the server to upload 118 the file/page 116 from the memory 112 of the appropriate file server, e.g. file server 110. The information on this page (See FIG. 3) may be used to augment the setup information remotely provided by the administrator by remote connection to each server or may largely replace the need for the above mentioned remote setup of each device, in the instance where the global configuration file/page itself includes the required information.

After configuration each image input device prompts the user for selection of a destination among a range of destinations, and for such additional information as may be appropriate to that destination as determined by the setup parameters entered by the administrator or updates thereto periodically acquired by the server(s) from time to time from the file transfer protocol (FTP) server 110.

After each image scanner is set up the scan server prompts the user for each image or set of images which is generated for the associated destination and such other header information as may be required. The server then sends the image and associated header to the selected destination. In the example shown packet 152, 172, 182, and 192 are sent from scanner 130 to client computer 150, mail server 170, database server 182 and fax server 192 respectively. Packet 152 includes a header 154 and an image 156. Packet 172 includes a header 174 and an image 176. Packet 182 includes a header 184 and an image 186. Packet 192 includes a header 194 and an image 196. In alternate embodiments of the invention the header and packet may be split into individual packets or attachments. In still another embodiment of the invention the header may be sent to a different destination than the image. Header information may vary depending on the destination for the image selected by the user. In still another embodiment of the invention the header and/or image portions of each packet may be sent to such additional locations as are specified in the configuration parameters uploaded into the server from the global configuration page. Thus for example, the configuration parameters may specify that each image and header packet sent to an e-mail server is also sent to an archival or backup server, e.g. file or database servers 110 or 180 for example.

FIG. 2 shows the data structures associated with an embodiment of the invention in which a portion of the setup of the image server is handled remotely on a device specific basis over the network. The portion of the administrative setup shown using this method includes mapping of logical and physical addresses and protocols specific to each destination. In this embodiment of the invention an administrator 122 using a network address associated with the selected image server, e.g. server 130 inputs via a computer, e.g. computer 120, the appropriate URL for the server and is presented 126 with one or more administrative web pages 124 delivered by the server 130. The first of these pages (Not shown) is a login page requiring appropriate user name and password. After a successful login the administrator is presented with a first and a second set of administrative setup pages. The first set includes page 124 on which are displayed various user selectable icons 200-208 corresponding to categories of destinations for the images acquired by the image acquiring device, e.g. scanner, digital copier, camera, coupled to the image server. The listed categories include but are not limited to: database servers 200, e-mail servers 202, file servers 204, printers or print servers 206, fax servers 208, etc. At the bottom of the page 124 a user selectable operational icon 210 allows the administrator to configure the server to automatically update/acquire all or part of its configuration parameters via the network and specifically via acquisition by the image server of a global configuration page from a file transfer server, e.g. server 110 or other server over the network 100. This latter feature greatly simplifies the network administrators task since each device can be reconfigured by generation of an updated global configuration page/file which is accessible by all image servers over the network. Provided each image server is so enabled updates will be performed automatically by each of the servers without further administrative involvement.

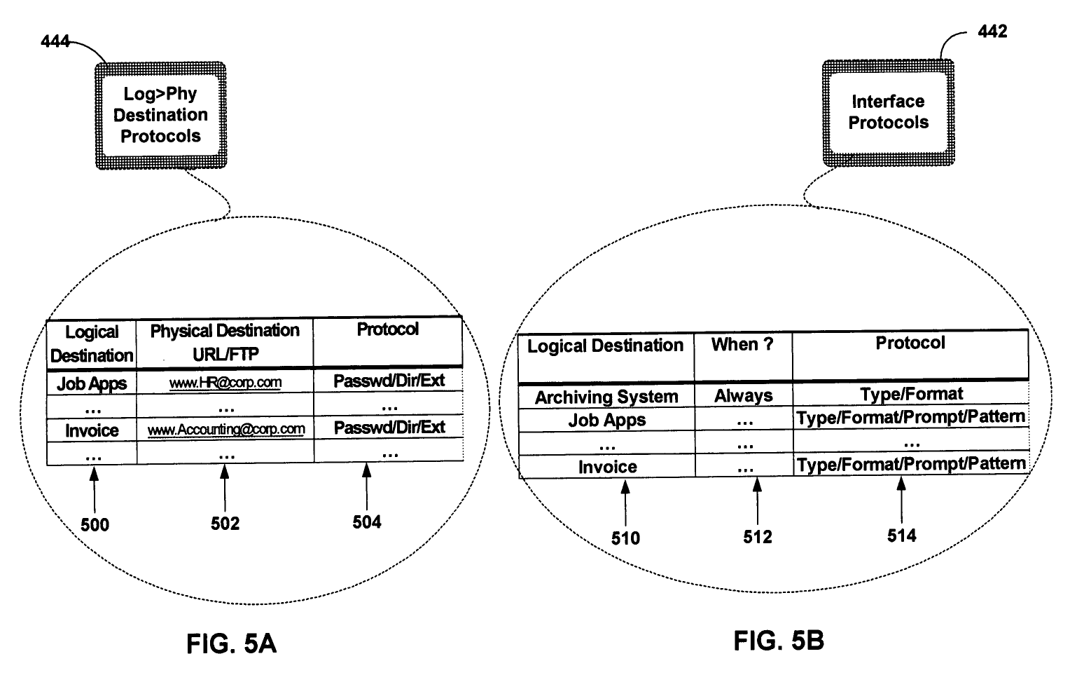

In the embodiment shown a user selection of the database server icon 200 results in the display in the browser application on whichever computer is utilized by the administrator to access the image server, of page 220. This page is supplied by the image server targeted by the administrator and includes entry fields for input of destination 222, URL 224, and may additionally include a field for database type/field mapping 226 for one or more database servers. An entry icon 228 allows submission of the administratively input data to the targeted image server where it will be stored in a corresponding setup configuration table 444 (See FIG. 5A) for example.

A user selection of the e-mail server icon 202 results in the display on the administrator's browser application, of page 230. This page is supplied by the image server targeted by the administrator and includes entry fields for input of destination 232, e-mail address 234, and method of attachment, as image 236 or as URL 238. An entry icon 240 allows submission of the administratively input data to the targeted image server where it will be stored in a corresponding setup configuration table 444 (See FIG. 5A) for example.

A user selection of the file server icon 204 results in the display on the administrator's browser application, of page 242. This page is supplied by the image server targeted by the administrator and includes entry fields for input of destination 244, FTP server name 246, user name 248, password 250, directory and file name 252 and may additionally include a field 254 for selecting the appropriate file format or file extension for the header block/file as be appropriate, e.g. .XML, .HTML, .JSP, .JAVA etc. An entry icon 256 allows submission of the administratively input data to the targeted image server where it will be stored in a corresponding setup configuration table 444 (See FIG. 5A) for example.

A user selection of the printer or print server icon 206 results in the display on the administrator's browser application, of page 260. This page is supplied by the image server targeted by the administrator and includes entry fields for input of destination 262, URL 264 and may additionally include a field for printer type 266. An entry icon 268 allows submission of the administratively input data to the targeted image server where it will be stored in a corresponding setup configuration table 444 (See FIG. 5A) for example.

A user selection of the fax or fax server icon 208 results in the display on the administrator's browser application, of page 270. This page is supplied by the image server targeted by the administrator and includes entry fields for input of destination 272, URL 274 and may additionally include a field for fax/fax server type 276. An entry icon 278 allows submission of the administratively input data to the targeted image server where it will be stored in a corresponding setup configuration table 444 (See FIG. 5A) for example.

A user selection of the operational or global configuration icon 210 results in the display on the administrator's browser application, of page 280. This page is supplied by the image server targeted by the administrator and includes entry fields for enabling or disabling global configurability via the global configuration page 116 shown in FIG. 1 and FIG. 3. Additional fields may include: an FTP server name field 288, user name and password fields 290-292 respectively, and a directory and file name field 294. An additional field may also include the reload/refresh/update interval field 296 which governs the time interval after which the image server will upload a fresh copy of the global configuration file 116. Any changes on the global configuration file/page result in a reconfiguration of the uploading image server.

In an alternate embodiment of the invention in which most of the configuration of the image server is performed via the global configuration file, web page 124 would include only the operational or global update/upload icon 210. In this embodiment of the invention the global configuration page (See FIG. 3) would include the parameters manually entered via pages 220,242,260 and 270 discussed above, thus avoiding the possibly redundant entry of such configuration parameters by the administrator on a device by device basis.

In still another embodiment of the invention the page 280 would include a alternate location for the above discussed parameters

FIG. 3 shows a global configuration page/file 116 which is accessible to the various scan servers shown in FIG. 1. The acquisition of this file by each of the image servers results in a reconfiguration of each of the image servers without administrative involvement. Updates made by the administrator to the global configuration page/file are propogated through the network via uploading by the various image acquisition servers at the end of the next reload interval.

In the embodiment shown the global configuration page/file is set forth in a markup language. In alternate embodiments of the invention the file could be defined as a table or some other data structure sufficient to embody the configuration detail required to globally configure the image servers. In the embodiment shown the global configuration parameters are expressed in Extended Markup language (XML). This language allows definition of a syntax and to structure data using markups. All markups start with an opening tag and stop with a closing tag. Such a pair of starting tag and closing tags is called an element. An element is the basic data structure. Further more each element can define attributes which set the value for a specific aspect of the element.

In the example shown in FIG. 3 there are three general destination blocks 302, 322, and 342 identified by start and close tags 300,318 and 320, 338 and 340, 358 respectively. The global configuration file/page 116 in this embodiment of the invention uses XML elements and attributes to structure the global configuration data.

At a general level the XML DD file contains two kinds of elements: the “AlwaysAsk” opening and closing tags 300, 318 respectively and the “Ask” opening and closing tags 320 together with 338 and 340 together with 358 respectively. The “AlwaysAsk” element, as its name indicates, defines entities which are relevant whichever destination the User selects. The “Ask” element, on the other hand, defines entities which are relevant only when the destination selected by the User matches the logical destination specified in the “When” element. In the example shown the first “When” element 324 portion of the first “Ask” element 322 sets global configuration parameters for the destination “Job Applications”. The second “When” element 344 associated with the second “Ask” element 342 sets the global configuration parameters for the destination “Invoice Department”. The only difference between the “AlwaysAsk” elements which define block 302 and the “Ask” elements which define blocks 322 and 342 is the condition to trigger them. While the “AlwaysAsk” element will always be triggered, the “Ask” element will be triggered only when the User selects the destination associated with the Ask element.

One of the aspects of this invention is the ability to globally configure for all image servers the information requested from the User in conjunction with the acquisition of the image. The element to define information requested from the User is called the “MetaData” element. The “MetaData” elements 304 in block 302, element 326 in block 322 and element 346 in block 342 are examples of such elements. This element have several attributes that will be used to determine the configuration of the image servers, when prompting the User in connection with the acquisition of an image. It is for instance possible to specify the text the User will see on the display 136 (See FIG. 1) of the image server. It is also possible to require that the value entered follows a certain pattern, and more generally to validate through a dynamic process, such as a script, the value entered. The attributes within the “MetaData” element(s) may be used to only allow the user to pick one value among a set of predefined values, such as is illustrated in element 304 of block 302. More generally any kind of information that would be relevant on a “per information” basis would be specified in that element.

An other aspect of this invention is to be able to control output of the scan server using the values entered by the User. The main element to structure the output is the “Output” element, e.g. output elements 310 in block 302, 328 in block 322 and 348 in block 342. The function of this element is to define two things. First of all the possible destination the output is aimed to. This is defined in a “To” element 308 such as is found in output element 310 within block 302. The “To” element describes the logical destination the output is aimed to and the image server is able to correlate the logical destination selected by the user with the physical destination configured by the administrator in the various pages shown in FIG. 2.

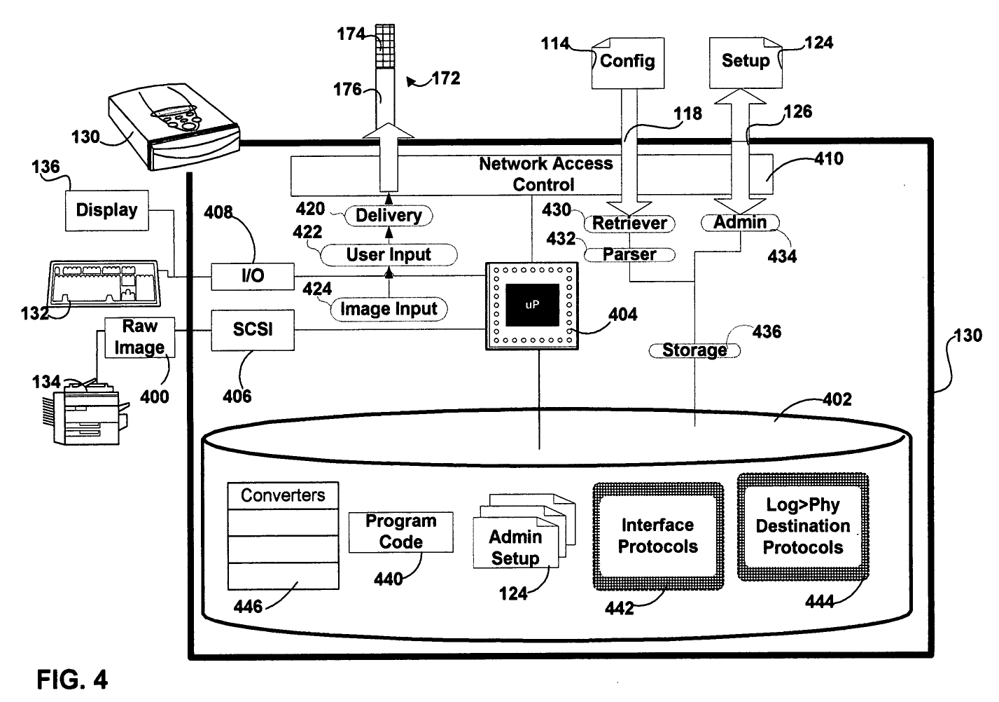

Attributes sufficient to configure the format of the output are contained within a “Format” element such as: format element 308 in block 302, format element 328 in block 322 or format element 348 in block 342. Formatting attributes can be used to invoke specific translators/converters on the corresponding image server (See FIG. 4) for conversion of image or header parameters before transmission. Formatting attributes may include commands or script which invoke desired responses or processes on the selected destination such as archiving or indexing of an archive. Where the destination is a database server the format attributes may be used to format the packet including header fields and image fields thereof in conformance with the post method which would trigger the integration of the image and header in appropriate fields and tables within the database. More generally any kind of action that can be triggered remotely could be achieved by this means.

FIG. 4 is a combined hardware and software module diagram for an embodiment of the scan server. The scan server 130 includes a processor 404, a memory 402, a network access control 410, a user I/O 408, and a small computer system interface (SCSI) or other suitable image input port 406 for communicating for receiving a raw image file(s) 400 from an associated image acquisition device, e.g. digital copier 134. The user I/O couples to the keyboard 132 and display 136. The network access control module includes a network interface, e.g. a media access control (MAC) and a packet assembler and disassembler (PAD) (not shown) for interfacing with the network 100 (See FIG. 1). The memory includes various data structures 124, 440, 442, 444 and 446. The program code 440 implements setup phase processes and run-time processes as determined by the program code operating and by the variable configuration parameters stored in the combined interface protocol table 442 and the translation tables 444. The blocks 430-436 correspond with setup phase software processes implemented by the above mentioned program code for validating and authenticating administrative access and accepting administrative configuration via display of appropriate administrative setup pages 126 stored in memory 402 and by acceptance and conversion of the setup parameters entered thereby for storage via processes 436 into the translation tables 444 in an appropriate format. Where configuration parameter retrieval from a global configuration page/file 116 (See FIG. 3) is enabled the retriever 430 processes handle periodic uploading of the global configuration file and the parser 432 processes handles the conversion of the elements thereof to appropriate control parameters which are stored in the interface protocol table 442.

During run-time processes 420-424 handle the acquisition of image input and any conversion thereof in image input processes 424; the prompting, validation and input of user inputs in user input processes 422, and the packaging of the image and user input in a single, or separate packet(s) and delivery thereof to one or more destinations as specified by the user and by any configuration parameters pertaining thereto in delivery processes 420.

FIG. 5A shows the data structures associated with logical-to-physical destination mapping and protocols therefore as found on the scan server after administrative setup in the translation tables 444. The translation table includes for each record therein a logical destination field 500, a corresponding physical destination field 502 and protocol fields 504. In the protocol fields any required passwords, directory, extensions or conversions may be recorded for each destination.

FIG. 5B shows the data structures associated with configuration of user interface procedures and image and header input parameters and formats after acquisition or updating of the global configuration file by the scan server. These are stored in the interface protocol table 442. The interface protocol table includes records with a logical destination field 510, a corresponding protocol therefore 514, and a field 512 indicating which of the destinations is the archival/backup destination to which all packets are copied.

FIG. 6A is a process flow diagram associated with administrative setup of an image server. Processing begins at start block 600 from which control is passed to process block 602. In process block 602 the global configuration file/page 116 (See FIG. 3) is created. It may be created manually by the administrator or ddynamically via an extensible style sheet language transformation (XSLT) or other such methodology for converting the header requirements of selected destinations into an XML or other file type suitable for a configuration page/file. Control is then passed to process 604 in which the global configuration file/page is loaded onto a target server, e.g. file server 110 and specifically storage 112 (See FIG. 1). Controlled is then passed to decision process 606. In decision process 606 a determination is made as to whether the next image server is to be configured. If it is then control is passed to process 608. In process 608 the network administrator 122 (See FIG. 1) inputs from any of the nodes on the network at which a browser application is available the appropriate URL for the targeted server. In response the targeted image server outputs an appropriate sequence of administrative setup pages 124 (See FIG. 2) and accepts the input therefrom to generate the translation tables 444 (See FIG. 4) in the memory of the targeted image server, e.g. server 130. Control is then passed to process 612. In process 612 the document server retrieves the global configuration/control file/page from the FTP or other server in which the control file is located. In an alternate embodiment of the invention the control file can be downloaded automatically from the central location to the targeted image server.

Control is then passed to decision process 614. In decision process 614 a determination is made by the image server as to whether the global configuration file/page is suitable for processing. In the event it is not control passes to process 618. In process 618 the error condition is trapped and supplied to the administrator. Control is then returned to process 602 for regeneration of the global configuration file/page 116. If alternately, in decision process 614 no error is detected then control is passed to decision process 616. In decision processing 616 a determination is made as to whether all eligible image servers have been configured. If more remain to be configured control returns decision process 606, otherwise setup is completed in finish block 620 marking the completion of the initial administrative setup phase.

FIG. 6B is a process flow diagram associated with run-time performance of a selected image server. The run-time performance of a selected image server begins at start block 650 from which control is passed to decision process 652. In decision process 652 a determination is made as to whether the user input or image input has been received by the server. In the event the determination is in the affirmative, control is passed to process 654. In process 654 the image server executes the appropriate user interface protocols determined by the program code operating in conjunction with the interface protocols table 442. Next in process 656 the user is prompted to and enters the requested values associated with each destination. Control then passes to decision process 658. In decision process 658 the user input is evaluated against any pattern matching or other configuration parameters designed to assure the integrity the header data. If the data entered matches the required pattern control passes to decision process 660. In decision process 660 a determination is made as to whether more header information is required from the user. If so control returns to process 654. If no more information is required control passes to process 662. In process 662 any required formatting is performed on the image file subsequent to which control is passed to process 664. In process 664 the information provided by the user is placed in a header file along with any associated formatting information which may be called for by the configuration files. Control is then passed to process 666. In process 666 the packet with the image file and header file is transmitted to the destination. Controlled then passes to decision process 668 in which a determination is made on the basis of the configuration files is to whether any alternate/default/archival/backup destination is called for. If it is control returns to process 662 for the formatting and sending of that packet. If alternately no further destinations are specified for the image file then control passes to decision process 670. In decision process 670 a determination is made as to whether the reload interval 296 (See FIG. 2) for the global configuration page/file 116 has expired. If it has then control passes to process 672 for reloading of the file after which control returns to decision process 652 for the detection of the next input event. If alternately in decision process 670 the reload interval has not expired then control returns directly to decision process 652.

It should be emphasised that the preferred embodiment described herein is in no way limiting and that many alternative embodiments are possible within the scope of protection defined by the appended claims. For example, other languages than XML could be used to define the required information.

In an alternate embodiment of the invention the FTP server 110 would signal each server when a new global configuration file or page was available, and in response thereto the servers would refresh the configuration file.

Although the nodes on the network are shown as clients or servers they may alternately include any device suitable for receipt of image and header data including for example personal digital assistants (PDAs) and cell phones.

In still another embodiment of the invention the need for the administrator to type in either remotely via access to each server or globally by means of the global configuration page/file 116 may be avoided when light weight directory access protocol (LDAP) are other comparable processes are provided by the corresponding destinations. In these embodiments of the invention logical to physical map tables would be automatically uploaded by processes 138 into each of the image servers.

The many features and advantages of the present invention are apparent from the written description, and thus, it is intended by the appended claims to cover all such features and advantages of the invention. Further, since numerous modifications and changes will readily occur to those skilled in the art, it is not desired to limit the invention to the exact construction and operation as illustrated and described. Hence, all suitable modifications and equivalents may be resorted to as falling within the scope of the invention.

1-14. (canceled)

15. An image server configured to couple at least one image input device to a network, and the image server comprising:
at least one table which identifies corresponding meta data for each destination of an image received from the at least one image input device;
a user input/output (I/O) device for user selection of a destination for an image and for prompting the user to enter the corresponding meta data for the selected destination as identified in the at least one table; and
a network access control configured to couple to the network for transmitting the image and the corresponding meta data entered by the user to the destination selected by the user via the user I/O device.

16. The image server of claim 15, wherein the at least one image input device comprises at least one of: a scanner, a digital copier, a camera, a multi-function printer, and a fax machine.

17. The image server of claim 15, wherein the corresponding meta data for each destination in the at least one table includes at least one of:
a mapping of a logical-to-physical destination;
an image format;
data input required from a user.

18. The image server of claim 15, wherein the user I/O device comprises:
a keyboard; and
a display.

19. A method of transmitting images across a network comprising:
acquiring an image;
accepting a user input of a destination for the acquired image;
identifying meta data requirements for the destination accepted from the user;
prompting the user for the identified meta data;
accepting meta data from the user responsive to the prompting act; and
transmitting the acquired image and the meta data accepted from the user to the user input destination.

20. The method of transmitting images of claim 19, wherein the acquiring act comprises at least one of the acts of:
acquiring the image from a scanner;
acquiring the image from a digital copier;
acquiring the image from a camera;
acquiring the image from a multi-function printer; and
acquiring the image from a fax machine.

21. The method of transmitting images of claim 19, wherein meta data requirements identified in the identifying act include at least one of:
a mapping of a logical-to-physical destination for the image;
an image format;
data input required from the user for the destination accepted from the user in the first accepting act.

22. The method of transmitting images of claim 19, wherein the identifying act further comprises at least one of the acts of:
periodically uploading meta data requirements from a global configuration file on the network; and
configuring the meta data requirements administratively from a plurality of device specific administrative setup pages.

23. The method of transmitting images of claim 19, further comprising the act prior to the transmitting act of:
converting the image to a format identified in the meta data accepted from the user.

24. The method of transmitting images of claim 19, wherein the act of accepting meta data from the user further comprises the act of:
validating the meta data accepted from the user.

25. A computer program product comprising:
a machine useable medium having computer program code embedded therein, the computer program product having:
computer readable program code to acquire an image;
computer readable program code to accept a user input of a destination for the acquired image;
computer readable program code to identify meta data requirements for the destination accepted from the user;
computer readable program code to prompt the user for the identified meta data;
computer readable program code to accept meta data entered by the user responsive to the prompt; and
computer readable program code to transmit the acquired image and the meta data accepted from the user to the destination accepted from the user.

26. The computer program product of claim 25 wherein the computer readable program code to acquire an image comprises at least one of:
computer readable program code to acquire the image from a scanner;
computer readable program code to acquire the image from a digital copier;
computer readable program code to acquire the image from a camera;
computer readable program code to acquire the image from a multi-function printer; and
computer readable program code to acquire the image from a fax machine.

27. The computer program product of claim 25 wherein the meta data identified by the computer readable program code to identify meta data requirements comprises at least one of:
a mapping of a logical-to-physical destination for the image;
an image format; and
a data input required from a user.

28. The computer program product of claim 25 wherein the computer readable program code to identify meta data requirements further comprises at least one of:
computer readable program code to periodically uploading meta data requirements from a global configuration file on the network; and
computer readable program code to configure the meta data requirements administratively from a plurality of device specific administrative setup pages.

29. The computer program product of claim 25 further comprising:
computer readable program code to convert the image file to a format entered by the user.

30. The computer program product of claim 25 further comprising:
computer readable program code to validate the meta data accepted from the user.
